(19) United States
(12) Patent Application Publication
(10) Pub. No.: US 2013/0106387 A1
(43) Pub. Date: May 2, 2013

(54) POWER SUPPLY

(71) Applicants: Hsin-Chung NIU, Taoyuan Hsien (TW); Te-Chih PENG, Taoyuan Hsien (TW)

(72) Inventors: Hsin-Chung NIU, Taoyuan Hsien (TW); Te-Chih PENG, Taoyuan Hsien (TW)

(21) Appl. No.: 13/550,898

(22) Filed: Jul. 17, 2012

(30) Foreign Application Priority Data
Nov. 1, 2011 (TW) 100139801

(51) Int. Cl. G05F 3/02

(52) U.S. Cl. 323/311; 323/304

(57) ABSTRACT

A power supply includes an output terminal, a power converting unit, an internal circuit and an internal power supplying unit. The output terminal outputs a first power. The power converting unit is coupled with the output terminal and receives the first power. The power converting unit converts the first power into a second power. The internal circuit is coupled with the power converting unit and receives the second power. The internal power supplying unit is coupled with the internal circuit.

### CROSS REFERENCE TO RELATED APPLICATIONS

This Non-provisional application claims priority under 35 U.S.C. §119(a) on Patent Application No(s). 100139801 filed in Taiwan, Republic of China on Nov. 1, 2011, the entire contents of which are hereby incorporated by reference.

### BACKGROUND OF THE INVENTION

1. Field of Invention

The present invention relates to a power supply and, in particular, to a power supply applied to an external load in non-loading or low loading status.

2. Related Art

The power supply is a commonly used device in our daily life. Almost all the electronic products comprise the power supply to provide power to other internal parts or electronic elements of the electronic products. When the status of the load changes, for example, between non-loading, low-loading and heavy loading, the power converting efficiency of the power supply may be varied.

FIG. 1 is a schematic diagram showing a conventional power supply 1. The power supply 1 comprises a power rectification unit 11 and an output terminal 12. The power rectification unit 11 is connected to the output terminal 12 for outputting an output voltage Vo through the output terminal 12 to the external load. Besides, in order to make the output voltage Vo of the power supply 1 to be a steady voltage or remained within a certain range as the external load is in non-loading or low-loading status, the conventional method is to configure multiple resistors R1, R2˜Rn, which can produce a loading to stabilize the output voltage Vo. However, when measuring the power efficiency of the power supply 1, since the resistors R1, R2˜Rn are disposed within the power supply 1, the resistors R1, R2˜Rn definitely would consume the power loss and result in the efficiency reduction of the whole system. Although removing the resistors R1, R2˜Rn can increase the power efficiency of the power supply 1, it would lead to unstable voltage output and produce ripple noise when the external load is in non- or low-loading status.

Therefore, it is an important subject to provide a power supply that can output a steady voltage, decrease loss of efficiency when the external load is in non- or low-loading status, improve the energy utilization rate of the power supply and reduce using of electronic elements, such as resistors, to decrease the production cost.

### SUMMARY OF THE INVENTION

In view of the foregoing subject, an object of the present invention is to provide a power supply to steady the output voltage and to reduce loss of efficiency when in low- or non-loading status to improve the energy utilization rate of the power supply.

In view of the foregoing subject, another object of the present invention is to provide a power supply to decrease the application or configuration of the electronic elements at the output terminal to reduce the production cost and save the space.

To achieve the above objects, the present invention provides a power supply including an output terminal, a power converting unit, an internal circuit and an internal power supplying unit. The output terminal outputs a first power. The power converting unit is coupled with the output terminal and receives the first power. The power converting unit converts the first power into a second power. The internal circuit is coupled with the power converting unit and receives the second power. The internal supplying unit is coupled with the internal circuit.

In a preferred embodiment of the present invention, the power converting unit comprises a zener diode and a resistor. Wherein, the resistor can be a current-limiting resistor.

In a preferred embodiment of the present invention, the internal circuit comprises at least one electronic device, which can be a chip, a resistor, a capacitor, a transistor or their combinations.

To achieve the above objects, the present invention also provides another power supply comprising a first output terminal, a power converting unit, a second output terminal, an internal circuit and an internal power supplying unit. The first output terminal outputs a first power. The power converting unit is coupled with the first output terminal and receives the first power. The power converting unit converts the first power to a second power. The second output is coupled with the power converting unit and outputs the second power. The internal power supplying unit is coupled with the internal circuit.

In a preferred embodiment of the present invention, the power supply further includes a control unit coupling with the power converting unit and the internal circuit. The control unit controls to provide the second power to the internal circuit or to the external load through the second output terminal.

In summary, the power supply of the present invention includes a power converting unit for converting the first power outputted to the second power. Specifically speaking, when the external load connected to the power supply is in non- or low-loading status, the power converting unit converts the redundant first power, which is not outputted to the external load, to the second power so as to provide power for the internal circuit or other external electronic devices. Accordingly, the power supply is more efficient in power utilization, thereby improving the power utilization rate.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic diagram showing a conventional power supply;

FIG. 2 is a schematic diagram showing a power supply according to a preferred embodiment of the present invention;

FIG. 3 is a schematic diagram showing a power converting unit according to the present invention;

FIG. 4 is a schematic diagram showing a power supply of another preferred embodiment of the present invention; and

FIG. 5 is a schematic diagram showing a power supply of still another embodiment of the present invention.

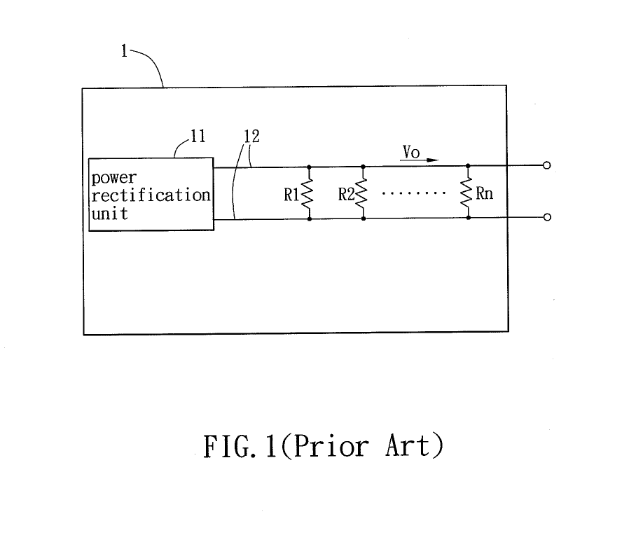

### DETAILED DESCRIPTION OF THE INVENTION

The present invention will be apparent from the following detailed description, which proceeds with reference to the accompanying drawings, wherein the same references relate to the same elements.

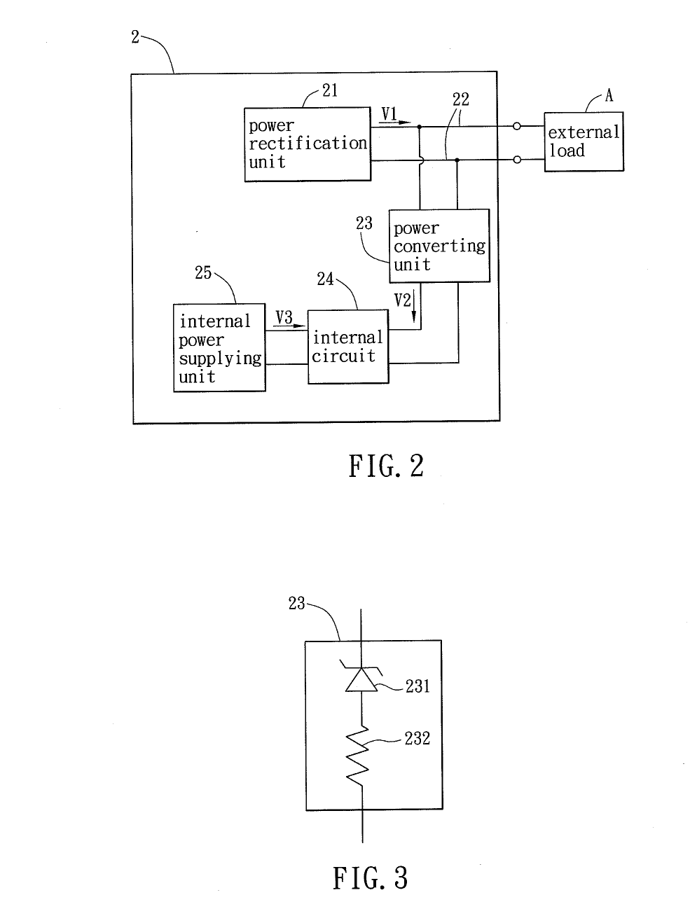

FIG. 2 is a schematic diagram showing a power supply 2 according to a preferred embodiment of the present invention. The power supply 2 includes a power rectification unit 21, an output terminal 22, a power converting unit 23, an internal circuit 24 and an internal power supplying unit 25. The power supply 2 is used to transfer the pubic alternating current power source to a steady direct current power source, for example 12V or 5V, to provide power to an external load A. To be noted, the power supply 2 of the present invention is applicable for an external load A in non- or low-loading status. Surely, the power supply 2 can also be in applicable for an external load A in heavy loading status. The external load A of the present invention can be but not limited to a fan, a lighting unit, a server, a computer system, or the likes. It is worth mentioned that the internal circuit 24 in the present invention is disposed within the power supply 2 and is used for operating and motivating the power supply 2. The internal power supplying unit 25 is used for providing power to the circuits within the power supply 2. The external load A is connected to the output terminal 22 of the power supply 2, and the external load A and the power supply 2 are configured separately.

The output terminal 22 is coupled with the power rectification unit 21. The output terminal 22 outputs a first power V1 produced by the power rectification unit 21.

The power converting unit 23 is coupled with the output terminal 22 and receives the first power V1. The power converting unit 23 converts the first power V1 to a second power V2. FIG. 3 is a schematic diagram showing a power converting unit according to the present invention. The power converting unit 23 includes a clamping circuit to tune the input voltage to the set direct-current voltage level. The clamping circuit comprises a zener diode 231 and a resistor 232. The zener diode 231 is connected to the resistor 232 in series. In this embodiment, the zener diode 231 functions to stabilize the voltage. The resistor 232 is a current-limiting resistor to avoid exceed current passing through the power converting unit 23. In details, for example, if the first power V1 is 12V, the power converting unit 23 receives the first power V1, and then the zener diode 231 and the resistor 232 convert the first power V1 (12V) to the second power V2 (e.g. 5V or 3V).

The internal circuit 24 is coupled with the power converting unit 23 and receives the second power V2. The internal circuit 24 comprises at least one electronic device (not shown), such as a chip, a resistor, a capacitor, a transistor or their combinations. In details, the internal circuit 24 receives the second power V2 and provides the second power V2 to the electronic device.

To be noted, when the power supply 2 connects to an external load A in heavy-loading status, the power rectification unit 21 outputs the first power V1 outputted by the output terminal 22 to the external load A. Otherwise, when the power supply 1 connects to an external load A in non- or low-loading status, the power converting unit 23 in this embodiment converts the first power V1 not outputted to the external load A to the second power V2 so as to provide power for the internal electronic device of the internal circuit 24. Thus, it can transfer the power loss for reuse to increase the energy utilization rate.

The internal power supplying unit 25 is coupled with the internal circuit 24 and outputs a third power V3 to the internal circuit 24. When the external load is in heavy-loading status, the power rectification unit 21 outputs all the first power V1 to the external load A through the output terminal 22. In addition, when the power converting unit 23 is unable to output the second power V2 to the internal circuit 24, the internal power supplying unit 25 outputs the third power V3 to the internal circuit 24.

When the external load is in low-loading status, the output terminal 22 outputs part of the first power V1 to the external load A, and the power converting unit 23 converts the rest of the first power V1 to the second power V2. If the second power V2 outputted by the power converting unit 23 is not enough to drive the internal circuit 24 to work, the internal power supplying unit 25 outputs the third V3 to the internal circuit 24 to drive the electronic device in the internal circuit 24 to function normally.

When the external load A is in non-loading status, the power converting unit 23 converts the first power V1 to the second power V2. If the second power V2 outputted by the power converting unit 23 is enough to drive the electronic device of the internal circuit 24 to work, the internal circuit 24 would not receive the third power V3 outputted by the internal power supplying unit 25. The embodiment mentioned above is only one of the examples of the invention and is not to limit the scope of the present invention.

Besides, the internal circuit 24 in this embodiment comprises a control unit (not shown). The control unit is used to control the internal circuit 24 to receive the second power V2 outputted by the power converting unit 23 or to receive the third power V3 outputted by the power supplying unit 25. Specifically speaking, when the second power V2 outputted by the power converting unit 23 is insufficient to motivate the internal circuit 24, the control unit of internal circuit 24 would connect the internal power supplying unit 25 to the internal circuit 24. Thus, the internal power supplying unit 25 outputs the third power V3 to the internal circuit 24 to provide the required power for the internal circuit 24 to make the internal electronic device of the internal circuit 24 function normally. When the second power V2 outputted by the power converting unit 23 is sufficient to motivate the internal circuit 24, the control unit of the internal circuit 24 would connect the power converting unit 23 and the internal circuit 24. Thus, the power converting unit 23 outputs the second power V2 to the internal circuit 24 to make the internal circuit 24 function normally. Accordingly, the internal circuit 24 does not receive the third power V3 outputted by the internal power supplying unit 25. The control unit can be, for example but not limited to, a transistor, a switch or a comparator.

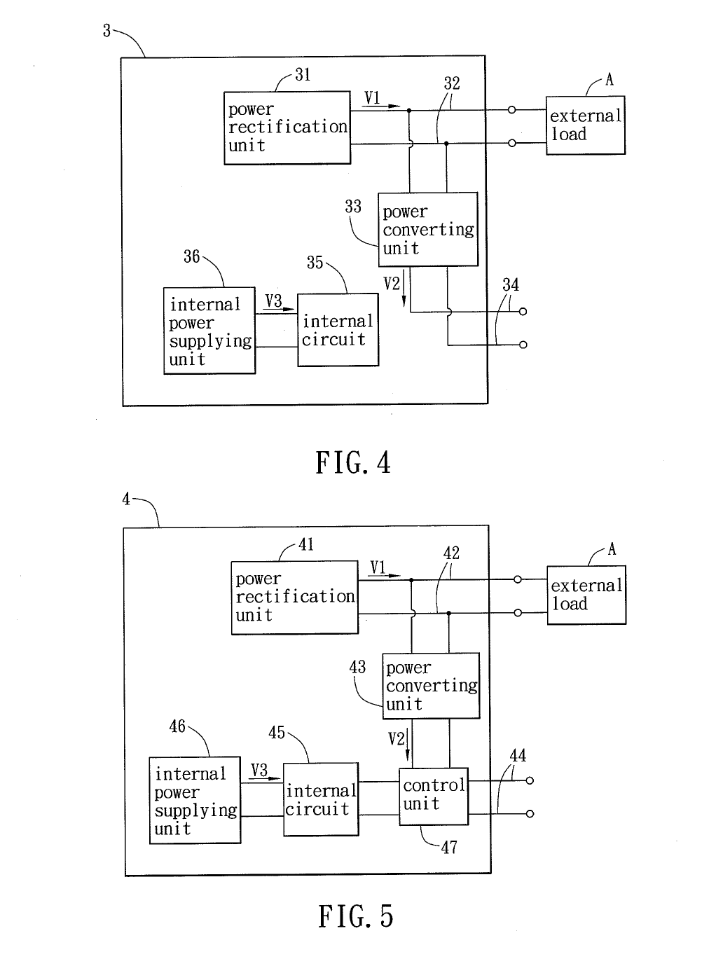

FIG. 4 is a schematic diagram showing a power supply 3 of another preferred embodiment of the present invention. The power supply 3 includes a power rectification unit 31, a first output terminal 32, a power converting unit 33, a second output terminal 34, an internal circuit 35 and an internal power supplying unit 36.

The first output terminal 32 is coupled with the power rectification unit 31. The first output terminal outputs a first power V1 produced by the power rectification unit 31.

The power converting unit 33 is coupled with the first output terminal 32 and receives the first power V1. The power converting unit 33 converts the first power V1 to a second power V2.

The second output terminal 34 is coupled with the power converting unit 33. The second output terminal 34 outputs the second power V2 produced by the power converting unit 33 and provides the second power V2 to other external electronic device, such as an USB connector, a keyboard, a fan, a mouse and etc.

The internal power supplying unit 36 is coupled with the internal circuit 35. The internal power supplying unit 36 provides a third power V3 to the internal circuit 35 so as to drive the internal circuit to function. Wherein, the internal circuit 35 comprises at least one electronic device. The at least one electronic device can be a chip, a resistor, a capacitor, a transistor or their combinations.

FIG. 5 is a schematic diagram showing a power supply 4 of still another embodiment of the present invention. The power supply 4 includes a power rectification unit 41, a first output terminal 42, a power converting unit 43, a second output terminal 44, an internal circuit 45 and an internal power supplying unit 46.

The difference between the power supply 4 of this embodiment and the above-mentioned power supply 3 is in that the power supply 4 further comprises a control unit 47 coupling with the power converting unit 43 and the internal circuit 45. The control unit 47 receives the second power V2 outputted by the power converting unit 43 and then provides to the internal circuit 45. Otherwise, the control unit 47 can receive the second power V2 outputted by the power converting unit 43, and then provides to the other external electronic devices through the second output terminal 44. Or, the control unit 47 can also receive the second power V2 outputted by the power converting unit 43, and then provides to the internal circuit 45 and the other external electronic devices through the second output terminal 44 at the same time. The control unit 47 of the embodiment can be, for example but not limited to, a transistor or a switch.

In summary, the power supply of the present invention includes a power converting unit for converting the first power outputted to the second power. Specifically speaking, when the external load connected to the power supply is in non- or low-loading status, the power converting unit converts the redundant first power, which is not outputted to the external load, to the second power so as to provide power for the internal circuit or other external electronic devices. By transferring the energy loss produced by stabilizing the first power voltage and reusing it, the power supply is more efficient in power utilization, thereby improving the power utilization rate.

Compared with the prior art, when the external load is in heavy loading status, the power supply of the present invention can normally provide power to the external load. Specifically when the external load is in non- or low-loading status, the power supply provides the redundant power to the internal circuit or the other external electronic devices to reduce the power loss, thereby improving the power utilization rate and diminishing the ripple noise. Besides, the power supply of the invention reduces the application of the electronic devices, such as resistors, at the output terminal so as to decrease the production cost and to save the space.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A power supply comprising:
an output terminal outputting a first power;
a power converting unit coupled with the output terminal for receiving the first power, wherein the power converting unit converts the first power into a second power;
an internal circuit coupled with the power converting unit for receiving the second power; and
an internal power supplying unit coupled with the internal circuit.

2. The power supply according to claim 1, wherein the power supply is applied to an external load and the external load is in non-loading or low loading status.

3. The power supply according to claim 1, wherein the power converting unit comprises a clamping circuit.

4. The power supply according to claim 3, wherein the clamping circuit comprises a zener diode and a resistor connected in series.

5. The power supply according to claim 1, wherein the internal circuit comprises at least an electronic device.

6. The power supply according to claim 5, wherein the electronic device is a chip, a resistor, a capacitor, a transistor or their combinations.

7. The power supply according to claim 1, wherein the internal power supplying unit outputs a third power to the internal circuit.

8. The power supply according to claim 7, wherein the internal circuit comprises a controller for controlling the internal circuit to receive the second power outputted by the power converting unit or the third power outputted by the internal power supplying unit.

9. A power supply comprising:
a first output terminal outputting a first power;
a power converting unit coupled with the first output terminal and receiving the first power, wherein the power converting unit converts the first power into a second power;
a second output terminal coupled with the power converting unit and outputting the second power;
an internal circuit; and
an internal power supplying unit coupled with the internal circuit.

10. The power supply according to claim 9, wherein the power supply is applied to an external load and the external load is in non-loading or low loading status.

11. The power supply according to claim 9, wherein the power converting unit comprises a clamping circuit.

12. The power supply according to claim 11, wherein the clamping circuit comprises a zener diode and a resistor connected in series.

13. The power supply according to claim 9, further comprising:
a control unit coupled with the power converting unit and the internal circuit.

14. The power supply according to claim 13, wherein the control unit is a transistor or a switch.

15. The power supply according to claim 9, wherein the internal circuit comprises at least an electronic device.

16. The power supply according to claim 15, wherein the electronic device is a chip, a resistor, a capacitor, a transistor or their combinations.

17. The power supply according to claim 9, wherein the internal power supplying unit outputs a third power to the internal circuit.

18. The power supply according to claim 17, wherein the internal circuit comprises a controller for controlling the internal circuit to receive the second power outputted by the power converting unit or the third power outputted by the internal power supplying unit.
